(19) United States
(12) Patent Application Publication
(10) Pub. No.: US 2025/0126692 A1
(43) Pub. Date: Apr. 17, 2025

(54) REAL-TIME CONSTANT ILLUMINANCE ADJUSTING SYSTEM AND METHOD THEREOF

(71) Applicant: Xiamen PVTECH Co., Ltd., Xiamen (CN)

(72) Inventors: FUXING LU, Xiamen (CN); RONGHUI WANG, Xiamen (CN)

(73) Assignee: Xiamen PVTECH Co., Ltd., Xiamen (CN)

(21) Appl. No.: 18/636,237

(22) Filed: Apr. 15, 2024

(30) Foreign Application Priority Data
Oct. 13, 2023 (CN) 202311324633.3

(51) Int. Cl. H05B 47/11; H05B 47/19

(52) U.S. Cl. CPC H05B 47/11; H05B 47/19

(57) ABSTRACT

A real-time constant illuminance adjusting system includes a lighting device and an illuminance adjusting device. The lighting device includes a first constant illuminance controller, a light source and a first illuminance detector connected thereto. The light source emits light. The first illuminance detector is disposed at a first location to detect the illuminance of the first location to generate a first illuminance value. The illuminance adjusting device is disposed at a second location, and includes a second constant illuminance controller and a second illuminance detector connected to each other. The second illuminance detector detects the illuminance of the second location to generate a second illuminance value, and the second illuminance value is transmitted to the first constant illuminance controller. The first constant illuminance controller calculates an illuminance converting parameter between the first location and the second location according to the first and second illuminance values.

### BACKGROUND OF THE INVENTION

### 1. Field of the Invention

The present invention relates to an illuminance adjusting system, in particular to a real-time constant illuminance adjusting system. The present invention further relates to the real-time constant illuminance adjusting method of the system.

### 2. Description of the Prior Art

With the advancement of technology, the demand for an improved quality of life has been increasing. Simultaneously, lighting systems have become more user-friendly. Lighting systems not only provide necessary illuminance for indoor and outdoor spaces but also, to some extent, influence the emotions and productivity of users.

To cater to diverse market needs, lighting systems with dimming function have emerged. However, the illuminance adjustment function of currently available lighting systems is overly complex and fails to effectively achieve constant illuminance, which cannot satisfy actual requirements. Therefore, it has become an important issue to provide an effective constant illuminance adjusting system.

China Patent Publication No.: CN114051300A and China Patent Publication No.: CN116321603A both disclose illuminance adjustment technologies, but neither effectively solves the above problems.

### SUMMARY OF THE INVENTION

One embodiment of the present invention provided a real-time constant illuminance adjusting system, which includes a lighting device and an illuminance adjusting device. The lighting device includes a first constant illuminance controller, a light source and a first illuminance detector connected to the first constant illuminance controller. The light source emits light. The first illuminance detector is disposed at a first location to detect the illuminance of the first location to generate a first illuminance value. The illuminance adjusting device is disposed at a second location, and includes a second constant illuminance controller and a second illuminance detector connected to each other. The second illuminance detector detects the illuminance of the second location to generate a second illuminance value, and the second constant illuminance controller transmits the second illuminance value to the first constant illuminance controller. The first constant illuminance controller calculates an illuminance converting parameter between the first location and the second location according to the first illuminance value and the second illuminance value.

In one embodiment, the first constant illuminance controller receives a target illuminance value to gradually adjust the brightness of the light source, and calculates the current illuminance value of the second position according to the illuminance detecting value of the first illuminance detector and the illuminance converting parameter. The first constant illuminance controller stops adjusting the brightness of the light source when the current illuminance value at the second location is equal to the target illuminance value.

In one embodiment, the first constant illuminance controller gradually adjusts the brightness of the light source when the ambient light changes, and calculates the current illuminance value of the second position according to the illuminance detecting value of the first illuminance detector and the illuminance converting parameter. The first constant illuminance controller stops adjusting the brightness of the light source when the current illuminance value at the second location is equal to the target illuminance value.

In one embodiment, the illuminance conversion parameter is the ratio of the second illuminance value to the first illuminance value.

In one embodiment, the real-time constant illuminance adjusting system further includes a light cover. The first constant illuminance controller and the light source are disposed inside the light cover, and the first illuminance detector is disposed on the outer surface or the inner surface of the light cover.

In one embodiment, the distance between the second location and the light source is greater than the distance between the first location and the light source.

Another embodiment of the present invention provided a real-time constant illuminance adjusting method, which includes the following steps: emitting a light by the light source of a lighting device; detecting the illuminance of a first location by a first illuminance detector of the lighting device to generate a first illuminance value; detecting the illuminance of a second location by a second illuminance detector of an illuminance adjusting device to generate a second illuminance value; transmitting the second illuminance value from a second constant illuminance controller of the illuminance adjusting device to a first constant illuminance controller of the lighting device; and calculating an illuminance converting parameter between the first location and the second location by the first constant illuminance controller of the lighting device according to the first illuminance value and the second illuminance value.

In one embodiment, the method further includes the following steps: receiving a target illuminance value by the first constant illuminance controller of the lighting device and gradually adjusting the brightness of the light source; calculating the current illuminance value of the second location according to the illuminance detecting value of the first illuminance detector and the illuminance converting parameter by the first constant illuminance controller of the lighting device; and stopping adjusting the brightness of the light source by the first constant illuminance controller of the lighting device when the current illuminance value of the second location is equal to the target illuminance value.

In one embodiment, the method further includes the following steps: gradually adjusting the brightness of the light source by the first constant illuminance controller of the lighting device when an ambient light changes; calculating the current illuminance value of the second location according to the illuminance detection value of the first illuminance detector and the illuminance converting parameter by the first constant illuminance controller of the lighting device; and stopping adjusting the brightness of the light source by the first constant illuminance controller of the lighting device when the current illuminance value of the second location is equal to the target illuminance value.

In one embodiment, the illuminance converting parameter is the ratio of the second illuminance value to the first illuminance value.

The real-time constant illuminance adjusting system and the method thereof in accordance with the embodiments of the present invention may have the following advantages:
(1) According to one embodiment of the present invention, the real-time constant illuminance adjusting system includes a lighting device and an illuminance adjusting device. The lighting device includes a first constant illuminance controller, a light source and a first illuminance detector connected to the first constant illuminance controller. The light source emits light. The first illuminance detector is disposed at a first location to detect the illuminance of the first location to generate a first illuminance value. The illuminance adjusting device is disposed at a second location, and includes a second constant illuminance controller and a second illuminance detector connected to each other. The second illuminance detector detects the illuminance of the second location to generate a second illuminance value, and the second constant illuminance controller transmits the second illuminance value to the first constant illuminance controller. The first constant illuminance controller calculates an illuminance converting parameter between the first location and the second location according to the first illuminance value and the second illuminance value. The first constant illuminance controller receives a target illuminance value and gradually adjusts the brightness of the light source, and the first constant illuminance controller calculates the current illuminance value of the second location based on the illuminance detecting value of the first illuminance detector and the illuminance conversing parameter. The first constant illuminance controller stops adjusting the brightness of the light source when the current illuminance value of the second location is equal to the target illuminance value. Via the illuminance converting mechanism described above, the real-time constant illuminance adjusting system ensures that the illuminance of the lighting device always stays at the target illuminance value so as to achieve real-time constant illuminance. Thus, the real-time constant illuminance adjusting system can conform to actual requirements.
(2) According to one embodiment of the present invention, the real-time constant illuminance adjusting system has the special illuminance converting mechanism. Even when ambient light changes, the system can still maintain the illuminance of the lighting device at the target illuminance value through the illuminance converting mechanism described above in order to achieve real-time constant illuminance. Therefore, the real-time constant illuminance adjusting system can be more comprehensive in application and more flexible in use.
(3) According to one embodiment of the present invention, the illuminance adjusting device of the real-time constant illuminance adjusting system can be removed or turned off after the initial setup process is executed to complete the calculation of the illuminance converting parameter. Therefore, the illuminance adjusting device does not need to continuously detect the illuminance of the second location. As a result, the energy consumption of the real-time constant illuminance adjusting system can be effectively reduced, so the system can be more environmentally friendly and in line with future development trends.
(4) According to one embodiment of the present invention, the first constant illuminance controller of the lighting device of the real-time constant illuminance adjusting system of the present invention can be directly powered by the power supply of the lighting device without the need for additional batteries. Consequently, the overall cost of the real-time constant illuminance adjusting system can be further reduced, and maintenance of the system becomes more convenient. Accordingly, reliability of the real-time constant illuminance adjusting system can be significantly improved.
(5) According to one embodiment of the present invention, the design of the real-time constant illuminance adjusting system is simple, so the real-time constant illuminance adjusting system can achieve desired technical effects without a significant increase in cost. Therefore, the real-time constant illuminance adjusting system can achieve higher practicality to meet the diverse needs of different applications.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of a real-time constant illuminance adjusting system in accordance with a first embodiment of the present invention.

FIG. 2 is a first schematic view of the real-time constant illuminance adjusting system in operation in accordance with the first embodiment of the present invention.

FIG. 3 is a second schematic view of the real-time constant illuminance adjusting system in operation in accordance with the first embodiment of the present invention.

FIG. 4 is a schematic view of a structure of the real-time constant illuminance adjusting system in accordance with the first embodiment of the present invention.

FIG. 5 is a first flow chart of a real-time constant illuminance adjusting method in accordance with a second embodiment of the present invention.

FIG. 6 is a second flow chart of the real-time constant illuminance adjusting method in accordance with the second embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

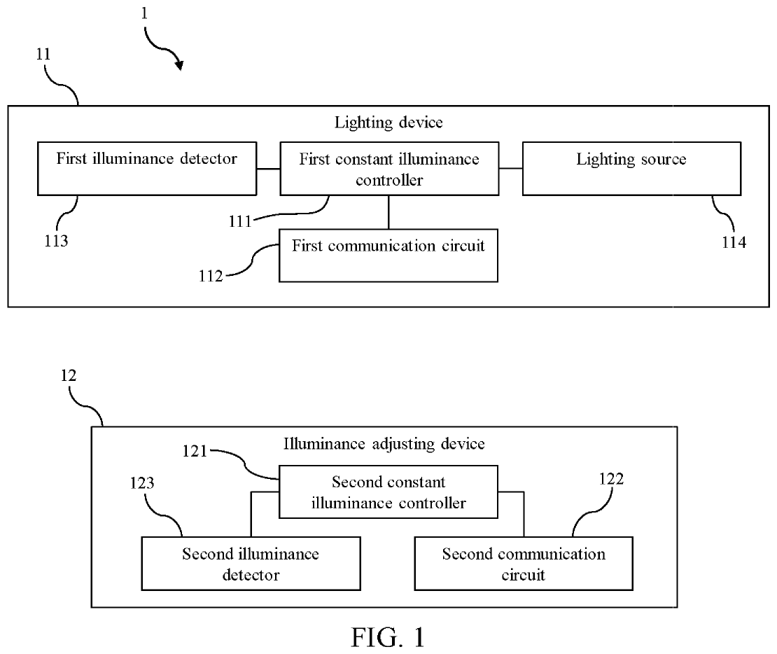

Please refer to FIG. 1, which is a block diagram of a real-time constant illuminance adjusting system in accordance with a first embodiment of the present invention. As shown in FIG. 1, the real-time constant illuminance adjusting system 1 includes a lighting device 11 and an illuminance adjusting device 12.

The lighting device 11 includes a first constant illuminance controller 111, a first communication circuit 112, a first illuminance detector 113, and a light source 114.

The light source 114 is connected to the first constant illuminance controller 111 and emits light. In this embodiment, the light source 114 may be a light emitting diode (LED). In another embodiment, the light source 114 may be a LED array or other similar components.

The first illuminance detector 113 is connected to the first constant illuminance controller 111. In the embodiment, the first illuminance detector 113 may be an optical sensor. In another embodiment, the first illuminance detector 113 may be other sensors capable of detecting illuminance.

The first communication circuit 112 is connected to the first constant illuminance controller 111. In the embodiment, the first communication circuit 112 may be a Bluetooth module. In another embodiment, the first communication circuit 112 may be a ZigBee module, a WiFi module or other similar components.

The first constant illuminance controller 111 may be a central-processing unit (CPU), a microcontroller unit (MCU), a field programmable gate array (FPGA) or similar components.

The illuminance adjusting device 12 is disposed at a second location, and includes a second constant illuminance controller 121, a second communication circuit 122, and a second illuminance detector 123.

The second communication circuit 122 is connected to the second constant illuminance controller 121. In the embodiment, the second constant illuminance controller 121 may be a Bluetooth module. In another embodiment, the second constant illuminance controller 121 may be a ZigBee module, a WiFi module or other similar components.

The second illuminance detector 123 is connected to the second constant illuminance controller 121. In the embodiment, the second illuminance detector 123 may be an optical sensor. In another embodiment, the second illuminance detector 123 may be other sensors capable of detecting illuminance.

The second constant illuminance controller 121 may be a central processor, a microcontroller, an application specific integrated circuit (ASIC), a field programmable gate array (FPGA) or similar components.

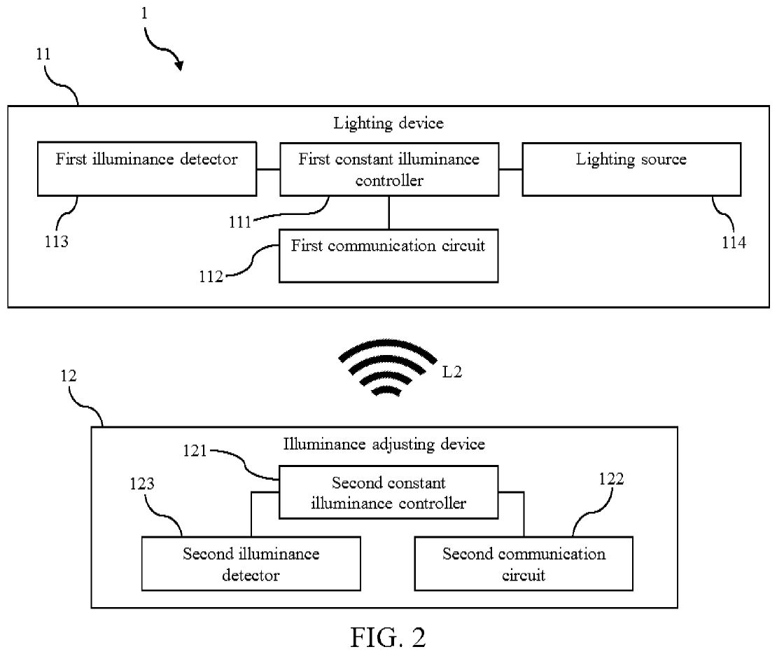

Refer to FIG. 2, which is a first schematic view of the real-time constant illuminance adjusting system in operation in accordance with the first embodiment of the present invention. As shown in FIG. 2, the first illuminance detector 113 of the lighting device 11 is disposed at a first location to detect the illuminance of the first position in order to generate a first illuminance value L1. In this embodiment, the first location can be on the outer surface of the light cover of the lighting device 11. In another embodiment, the first location may be located at the inner surface of the light cover of the lighting device 11.

The second illuminance detector 123 of the illuminance adjusting device 12 detects the illuminance at the second location (the target location) to generate the second illuminance value L2 of the second location. The second constant illuminance controller 121 of the illuminance adjusting device 12 transmits the second illuminance value L2 to the first constant illuminance controller 111 of the lighting device 11. The first constant illuminance controller 111 calculates the illuminance converting parameter between the first and second locations based on the first and second illuminance values L1 and L2. The illuminance converting parameter is the ratio of the second illuminance value L2 to the first illuminance value L1, as shown in Equation (1) given below:

$$L 2 = X \times L 1. \qquad ( 1 )$$

In Equation (1), X stands for the illuminance converting parameter; Equation (2) can be obtained based on Equation (1). Equation (2) is as follows:

$$X = L 1 / L 2. . \qquad ( 2 )$$

The user can also directly set a preset illuminance value as the second illuminance value L2 through an electronic device (such as a smartphone, a tablet computer, a laptop computer, etc.). Then, the first constant illuminance controller of the lighting device 11 gradually increases the brightness of the light source 114 until the second illuminance detector 123 of the illuminance adjusting device 12 detects that the illuminance of the second position has reached the second illuminance value L2. Finally, the first constant illuminance controller 111 of the lighting device 11 calculates the illuminance converting parameter between the first and second positions based on the first illuminance value L1 and the second illuminance value L2. The illuminance converting parameter represents the illuminance relation between the first and second positions.

After obtaining the illuminance converting parameter, the real-time constant illuminance adjusting system 1 can execute a special illuminance converting mechanism. The user can set a target illuminance value through electronic device and transmit the target illuminance value to the first constant illuminance controller 111 of the lighting device 11. Upon receiving the target illuminance value, the first constant illuminance controller 111 of the lighting device 11 gradually adjusts the brightness of the light source 114 and calculates the current illuminance value of the second position based on the illuminance detecting value of the first illuminance detector 113 and the illuminance converting parameter. The first constant illuminance controller 111 of the lighting device 11 stops adjusting the brightness of the light source 114 when the current illuminance value of the second position is equal to the target illuminance value.

Through the above illuminance converting mechanism, the first constant illuminance controller 111 of the lighting device 11 can estimate the current illuminance value of the second position based on the illuminance converting parameter and the illuminance detecting value of the first position. In the meanwhile, the first constant illuminance controller 111 of the lighting device 11 gradually adjusts the brightness of the light source 114. Then, the first constant illuminance controller 111 of the lighting device 11 can stop adjusting the brightness of the light source 114 when the estimated current illuminance value at the second position is equal to the target illuminance value. This illuminance converting mechanism can ensure that the illuminance of the lighting device 11 always remains at the target illuminance value, achieving real-time illuminance constancy. Therefore, the real-time constant illuminance adjusting system 1 meets actual requirements.

The illuminance adjusting device 12 can be removed or turned off after completing the initial setup program to calculate the illuminance converting parameter. Therefore, the energy consumption of the real-time constant illuminance adjusting system 1 can be effectively reduced, so the real-time constant illuminance adjusting system 1 cam be more environmentally friendly and in line with future development trends.

Furthermore, the first constant illuminance controller 111 of the lighting device 11 in the real-time constant illuminance adjusting system 1 can be directly powered by the power supply of the lighting device 11 without the need for additional batteries. Therefore, the overall cost of the real-time constant illuminance adjusting system 1 can be further reduced, and maintenance can be more convenient. This significantly enhances the reliability of the real-time constant illuminance adjusting system 1.

The embodiment just exemplifies the present invention and is not intended to limit the scope of the present invention; any equivalent modification and variation according to the spirit of the present invention is to be also included within the scope of the following claims and their equivalents.

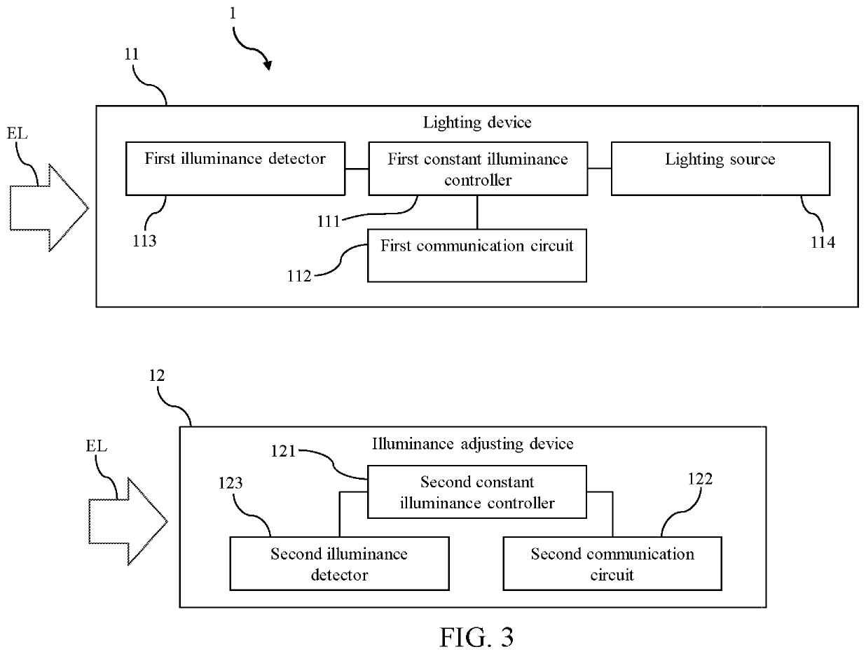

Please refer to FIG. 3, which is a second schematic view of the real-time constant illuminance adjusting system in operation in accordance with the first embodiment of the present invention. As shown in FIG. 3, when the ambient light EL changes (the brightness of the ambient light EL increases or decreases), the first constant illuminance controller 111 of the lighting device 11 adjusts the brightness of the light source 114, and calculates the current illuminance value of the second location according to the illuminance detecting value of the first illuminance detector 113 and the illuminance converting parameter. The adjustment stops when the current illuminance value at the second location is equal to the target illuminance value.

For instance, when the ambient light EL increases, the first constant illuminance controller 111 decreases the brightness of the light source 114 of the lighting device 111, and calculates the current illuminance value of the second location according to the illuminance detecting value of the first illuminance detector 113 and the illuminance converting parameter. The first constant illuminance controller 111 stops decreasing the brightness of the light source 114 of the lighting device 111 until the current illuminance value at the second location is equal to the target illuminance value.

On the contrary, when the ambient light EL decreases, the first constant illuminance controller 111 increases the brightness of the light source 114 of the lighting device 111, and calculates the current illuminance value of the second location according to the illuminance detecting value of the first illuminance detector 113 and the illuminance converting parameter. The first constant illuminance controller 111 stops increasing the brightness of the light source 114 of the lighting device 111 until the current illuminance value at the second location is equal to the target illuminance value.

As previously stated, the real-time constant illuminance adjusting system 1 can maintain the illuminance of the lighting device 11 at the target illuminance value despite changes in ambient light. Therefore, the real-time constant illuminance adjusting system 1 can be more comprehensive in application and more flexible in use.

The embodiment just exemplifies the present invention and is not intended to limit the scope of the present invention; any equivalent modification and variation according to the spirit of the present invention is to be also included within the scope of the following claims and their equivalents.

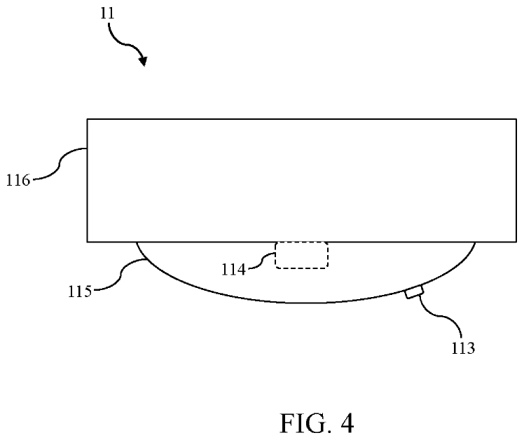

Please refer to FIG. 4, which is a schematic view of a structure of the real-time constant illuminance adjusting system in accordance with the first embodiment of the present invention. As shown in FIG. 4, the lighting device 11 may include a light cover and a lamp body 116. The first constant illuminance controller 111, the first communication circuit 112, and the light source 114 can be disposed inside the light cover 115, and between the light cover 115 and the lamp body 116. The first illuminance detector 113 can be disposed on the outer surface (the first location) of the light cover 115. In another embodiment, the first location may also be the inner surface of the light cover 115.

The embodiment just exemplifies the present invention and is not intended to limit the scope of the present invention; any equivalent modification and variation according to the spirit of the present invention is to be also included within the scope of the following claims and their equivalents.

It is worthy to point out that the illuminance adjustment function of currently available lighting systems is overly complex and fails to effectively achieve constant illuminance, which cannot satisfy actual requirements. By contrast, according to one embodiment of the present invention, the real-time constant illuminance adjusting system includes a lighting device and an illuminance adjusting device. The lighting device includes a first constant illuminance controller, a light source and a first illuminance detector connected to the first constant illuminance controller. The light source emits light. The first illuminance detector is disposed at a first location to detect the illuminance of the first location to generate a first illuminance value. The illuminance adjusting device is disposed at a second location, and includes a second constant illuminance controller and a second illuminance detector connected to each other. The second illuminance detector detects the illuminance of the second location to generate a second illuminance value, and the second constant illuminance controller transmits the second illuminance value to the first constant illuminance controller. The first constant illuminance controller calculates an illuminance converting parameter between the first location and the second location according to the first illuminance value and the second illuminance value. The first constant illuminance controller receives a target illuminance value and gradually adjusts the brightness of the light source, and the first constant illuminance controller calculates the current illuminance value of the second location based on the illuminance detecting value of the first illuminance detector and the illuminance conversing parameter. The first constant illuminance controller stops adjusting the brightness of the light source when the current illuminance value of the second location is equal to the target illuminance value. Via the illuminance converting mechanism described above, the real-time constant illuminance adjusting system ensures that the illuminance of the lighting device always stays at the target illuminance value so as to achieve real-time constant illuminance. Thus, the real-time constant illuminance adjusting system can conform to actual requirements.

Also, according to one embodiment of the present invention, the real-time constant illuminance adjusting system has the special illuminance converting mechanism. Even when ambient light changes, the system can still maintain the illuminance of the lighting device at the target illuminance value through the illuminance converting mechanism described above in order to achieve real-time constant illuminance. Therefore, the real-time constant illuminance adjusting system can be more comprehensive in application and more flexible in use.

Further, according to one embodiment of the present invention, the illuminance adjusting device of the real-time constant illuminance adjusting system can be removed or turned off after the initial setup process is executed to complete the calculation of the illuminance converting parameter. Therefore, the illuminance adjusting device does not need to continuously detect the illuminance of the second location. As a result, the energy consumption of the real-time constant illuminance adjusting system can be effectively reduced, so the system can be more environmentally friendly and in line with future development trends.

Moreover, according to one embodiment of the present invention, the first constant illuminance controller of the lighting device of the real-time constant illuminance adjusting system of the present invention can be directly powered by the power supply of the lighting device without the need for additional batteries. Consequently, the overall cost of the real-time constant illuminance adjusting system can be further reduced, and maintenance of the system becomes more convenient. Accordingly, reliability of the real-time constant illuminance adjusting system can be significantly improved.

Furthermore, according to one embodiment of the present invention, the design of the real-time constant illuminance adjusting system is simple, so the real-time constant illuminance adjusting system can achieve desired technical effects without a significant increase in cost. Therefore, the real-time constant illuminance adjusting system can achieve higher practicality to meet the diverse needs of different applications. As described above, the real-time constant illuminance adjusting system according to the embodiments of the present invention can definitely achieve great technical effects.

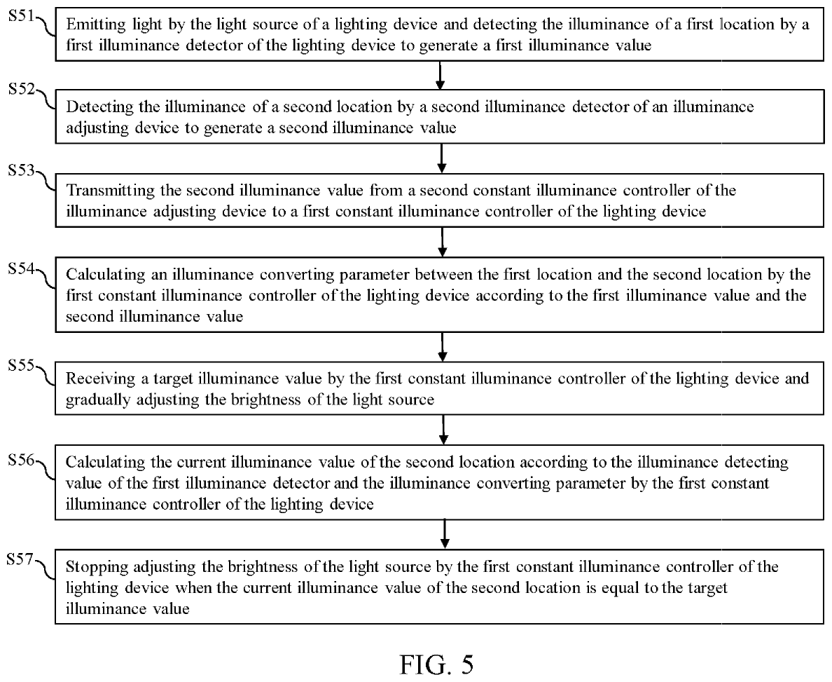

Please refer to FIG. 5, which is a first flow chart of a real-time constant illuminance adjusting method in accordance with a second embodiment of the present invention. As shown in FIG. 5, the real-time constant illuminance adjusting method of this embodiment includes the following steps:
Step S51: emitting light by the light source of a lighting device and detecting the illuminance of a first location by a first illuminance detector of the lighting device to generate a first illuminance value.
Step S52: detecting the illuminance of a second location by a second illuminance detector of an illuminance adjusting device to generate a second illuminance value.
Step S53: transmitting the second illuminance value from a second constant illuminance controller of the illuminance adjusting device to a first constant illuminance controller of the lighting device.
Step S54: calculating an illuminance converting parameter between the first location and the second location by the first constant illuminance controller of the lighting device according to the first illuminance value and the second illuminance value.
Step S55: receiving a target illuminance value by the first constant illuminance controller of the lighting device and gradually adjusting the brightness of the light source.
Step S56: calculating the current illuminance value of the second location according to the illuminance detecting value of the first illuminance detector and the illuminance converting parameter by the first constant illuminance controller of the lighting device.
Step S57: stopping adjusting the brightness of the light source by the first constant illuminance controller of the lighting device when the current illuminance value of the second location is equal to the target illuminance value.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

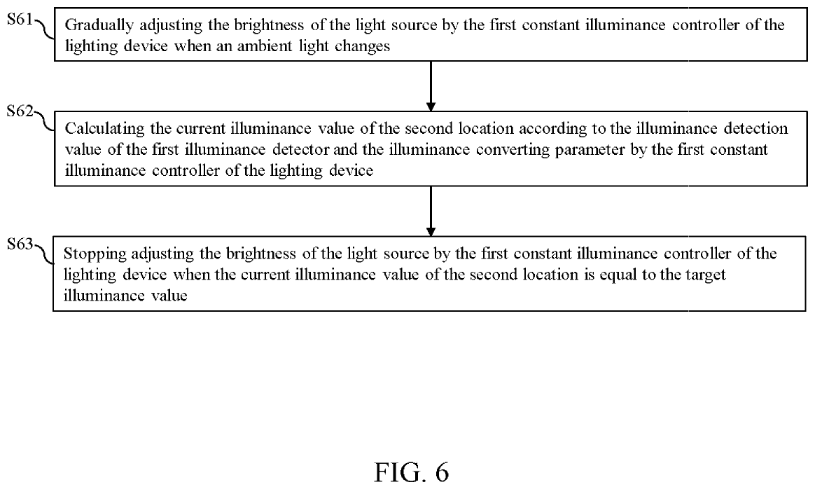

Please refer to FIG. 6, which is a second flow chart of the real-time constant illuminance adjusting method in accordance with the second embodiment of the present invention. As shown in FIG. 6, the real-time constant illuminance adjusting method of this embodiment further includes the following steps:
Step S61: gradually adjusting the brightness of the light source by the first constant illuminance controller of the lighting device when an ambient light changes.
Step S62: calculating the current illuminance value of the second location according to the illuminance detection value of the first illuminance detector and the illuminance converting parameter by the first constant illuminance controller of the lighting device.
Step S63: stopping adjusting the brightness of the light source by the first constant illuminance controller of the lighting device when the current illuminance value of the second location is equal to the target illuminance value.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the real-time constant illuminance adjusting system includes a lighting device and an illuminance adjusting device. The lighting device includes a first constant illuminance controller, a light source and a first illuminance detector connected to the first constant illuminance controller. The light source emits light. The first illuminance detector is disposed at a first location to detect the illuminance of the first location to generate a first illuminance value. The illuminance adjusting device is disposed at a second location, and includes a second constant illuminance controller and a second illuminance detector connected to each other. The second illuminance detector detects the illuminance of the second location to generate a second illuminance value, and the second constant illuminance controller transmits the second illuminance value to the first constant illuminance controller. The first constant illuminance controller calculates an illuminance converting parameter between the first location and the second location according to the first illuminance value and the second illuminance value. The first constant illuminance controller receives a target illuminance value and gradually adjusts the brightness of the light source, and the first constant illuminance controller calculates the current illuminance value of the second location based on the illuminance detecting value of the first illuminance detector and the illuminance conversing parameter. The first constant illuminance controller stops adjusting the brightness of the light source when the current illuminance value of the second location is equal to the target illuminance value. Via the illuminance converting mechanism described above, the real-time constant illuminance adjusting system ensures that the illuminance of the lighting device always stays at the target illuminance value so as to achieve real-time constant illuminance. Thus, the real-time constant illuminance adjusting system can conform to actual requirements.

Also, according to one embodiment of the present invention, the real-time constant illuminance adjusting system has the special illuminance converting mechanism. Even when ambient light changes, the system can still maintain the illuminance of the lighting device at the target illuminance value through the illuminance converting mechanism described above in order to achieve real-time constant illuminance. Therefore, the real-time constant illuminance adjusting system can be more comprehensive in application and more flexible in use.

Further, according to one embodiment of the present invention, the illuminance adjusting device of the real-time constant illuminance adjusting system can be removed or turned off after the initial setup process is executed to complete the calculation of the illuminance converting parameter. Therefore, the illuminance adjusting device does not need to continuously detect the illuminance of the second location. As a result, the energy consumption of the real-time constant illuminance adjusting system can be effectively reduced, so the system can be more environmentally friendly and in line with future development trends.

Moreover, according to one embodiment of the present invention, the first constant illuminance controller of the lighting device of the real-time constant illuminance adjusting system of the present invention can be directly powered by the power supply of the lighting device without the need for additional batteries. Consequently, the overall cost of the real-time constant illuminance adjusting system can be further reduced, and maintenance of the system becomes more convenient. Accordingly, reliability of the real-time constant illuminance adjusting system can be significantly improved.

Furthermore, according to one embodiment of the present invention, the design of the real-time constant illuminance adjusting system is simple, so the real-time constant illuminance adjusting system can achieve desired technical effects without a significant increase in cost. Therefore, the real-time constant illuminance adjusting system can achieve higher practicality to meet the diverse needs of different applications.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A real-time constant illuminance adjusting system, comprising:
a lighting device comprising a first constant illuminance controller, a light source and a first illuminance detector connected to the first constant illuminance controller, wherein the light source emits a light, and the first illuminance detector is disposed at a first location to detect an illuminance of the first location to generate a first illuminance value; and
an illuminance adjusting device disposed at a second location and comprising a second constant illuminance controller and a second illuminance detector connected to each other, wherein the second illuminance detector detects an illuminance of the second location to generate a second illuminance value, and the second constant illuminance controller transmits the second illuminance value to the first constant illuminance controller, wherein first the t constant illuminance controller calculates an illuminance converting parameter between the first location and the second location according to the first illuminance value and the second illuminance value.

2. The real-time constant illuminance adjusting system as claimed in claim 1, wherein the first constant illuminance controller receives a target illuminance value to gradually adjust a brightness of the light source, and calculates a current illuminance value of the second position according to an illuminance detecting value of the first illuminance detector and the illuminance converting parameter, wherein the first constant illuminance controller stops adjusting the brightness of the light source when the current illuminance value at the second location is equal to the target illuminance value.

3. The real-time constant illuminance adjusting system as claimed in claim 2, wherein the first constant illuminance controller gradually adjusts the brightness of the light source when an ambient light changes, and calculates the current illuminance value of the second position according to the illuminance detecting value of the first illuminance detector and the illuminance converting parameter, wherein the first constant illuminance controller stops adjusting the brightness of the light source when the current illuminance value at the second location is equal to the target illuminance value.

4. The real-time constant illuminance adjusting system as claimed in claim 1, wherein the illuminance conversion parameter is a ratio of the second illuminance value to the first illuminance value.

5. The real-time constant illuminance adjusting system as claimed in claim 1, further comprising a light cover, wherein the first constant illuminance controller and the light source are disposed inside the light cover, and the first illuminance detector is disposed on an outer surface or an inner surface of the light cover.

6. The real-time constant illuminance adjusting system as claimed in claim 1, wherein a distance between the second location and the light source is greater than a distance between the first location and the light source.

7. A real-time constant illuminance adjusting method, comprising:
emitting a light by a light source of a lighting device;
detecting an illuminance of a first location by a first illuminance detector of the lighting device to generate a first illuminance value;
detecting an illuminance of a second location by a second illuminance detector of an illuminance adjusting device to generate a second illuminance value;
transmitting the second illuminance value from a second constant illuminance controller of the illuminance adjusting device to a first constant illuminance controller of the lighting device; and
calculating an illuminance converting parameter between the first location and the second location by the first constant illuminance controller of the lighting device according to the first illuminance value and the second illuminance value.

8. The real-time constant illuminance adjusting method as claimed in claim 7, further comprising:
receiving a target illuminance value by the first constant illuminance controller of the lighting device and gradually adjusting a brightness of the light source;
calculating a current illuminance value of the second location according to the illuminance detecting value of the first illuminance detector and the illuminance converting parameter by the first constant illuminance controller of the lighting device; and
stopping adjusting the brightness of the light source by the first constant illuminance controller of the lighting device when the current illuminance value of the second location is equal to the target illuminance value.

9. The real-time constant illuminance adjusting method as claimed in claim 8, further comprising:
gradually adjusting the brightness of the light source by the first constant illuminance controller of the lighting device when an ambient light changes;
calculating the current illuminance value of the second location according to the illuminance detection value of the first illuminance detector and the illuminance converting parameter by the first constant illuminance controller of the lighting device; and
stopping adjusting the brightness of the light source by the first constant illuminance controller of the lighting device when the current illuminance value of the second location is equal to the target illuminance value.

10. The real-time constant illuminance adjusting method as claimed in claim 7, wherein the illuminance converting parameter is a ratio of the second illuminance value to the first illuminance value.
